(19) United States
(12) Patent Application Publication
(10) Pub. No.: US 2007/0039830 A1
(43) Pub. Date: Feb. 22, 2007

(54) Cationic electrodeposition coating composition and method of stabilizing cationic electrodeposition coating compositions

(76) Inventors: Kazuo Morichika, Neyagawa-shi (JP); Toshitaka Kawanami, Neyagawa-shi (JP); Hiroyuki Sakamoto, Neyagawa-shi (JP)

Correspondence Address: CONNOLLY BOVE LODGE & HUTZ LLP, P.O. BOX 2207, WILMINGTON, DE, 19899-2207, US

(21) Appl. No.: 10/548,537

(22) PCT Filed: Mar. 11, 2004
(86) PCT No.: PCT/JP04/03245

§ 371 Date: Sep. 5, 2006

(30) Foreign Application Priority Data
Mar. 11, 2003 (JP) 2003-065645

(51) Int. Cl. C25D 9/00; C25D 9/02; B32B 27/00

(52) U.S. Cl. 205/316; 205/317

(57) ABSTRACT

It is an object of the present invention to provide a sulfonium group- and propargyl group-containing cationic electrodeposition coating composition whose curability can be enhanced without using any heavy metal-containing metal catalyst and which is further excellent in storage stability in a stationary state as well as a method of stabilizing cationic electrodeposition coating compositions. A cationic electrodeposition coating composition comprising a sulfonium group- and propargyl group-containing resin composition and a copper catalyst, the copper catalyst being a long-chain alkylsulfonic acid copper salt.

### TECHNICAL FIELD

The present invention relates to a cationic electrodeposition coating composition and to a method of stabilizing cationic electrodeposition coating compositions.

### BACKGROUND ART

Cationic electrodeposition coating compositions comprising a sulfonium group- and propargyl group-containing resin composition are disclosed in WO 98/03595 and Japanese Kokai Application 2000-38525. They are high in bath stability and excellent in electrodeposited coating film curability. These cationic electrodeposition coating compositions have been designed according to an idea different from the conventional idea of electrodeposition coating compositions comprising an amine-modified epoxy resin and a blocked isocyanate curing agent and are characterized in that no volatile matter generation occurs in the step of baking, hence the load on the environment is light.

However, when the curability of these electrodeposition coating compositions is to be enhanced, it is necessary to use a metal catalyst containing a heavy metal such as cobalt or nickel, which may possibly exert an adverse effect on the environment.

Moreover, such cationic electrodeposition coating compositions are poor in storage stability in a stationary state in some cases. Thus, when stored without stirring, the properties of the cationic electrodeposition coating compositions tend to change and, when the cationic electrodeposition coating compositions after storage are applied, there arises the problem of poor coating film appearance. In certain instances, the coating compositions are required to be stored for a certain period from the preparation to the actual application thereof and, therefore, such situation is undesirable. Thus, the advent of a cationic electrodeposition coating composition undergoing no changes in quality even after a long period of storage has been waited for.

### SUMMARY OF THE INVENTION

In view of the foregoing, it is an object of the present invention to provide a sulfonium group- and propargyl group-containing cationic electrodeposition coating composition whose curability can be enhanced without using any heavy metal-containing metal catalyst and which is further excellent in storage stability in a stationary state as well as a method of stabilizing cationic electrodeposition coating compositions.

The present invention provides a cationic electrodeposition coating composition comprising a sulfonium group- and propargyl group-containing resin composition and a copper catalyst,

said copper catalyst being a long-chain alkylsulfonic acid copper salt.

Preferably, the long-chain alkyl group in the long-chain alkylsulfonic acid copper salt contains 6 to 24 carbon atoms.

The present invention also provides a method of stabilizing cationic electrodeposition coating compositions comprising a sulfonium group- and propargyl group-containing resin composition and a copper catalyst,

said method comprising using a long-chain alkylsulfonic acid copper salt or a long-chain alkylsulfuric acid copper salt as the copper catalyst.

In the method of stabilizing cationic electrodeposition coating compositions,

the long-chain alkyl group in the long-chain alkylsulfonic acid copper salt or long-chain alkylsulfuric acid copper salt preferably contains 6 to 24 carbon atoms.

### DETAILED DESCRIPTION OF THE INVENTION

Hereinafter, the present invention will be described in detail.

The cationic electrodeposition coating composition of the present invention contains a copper catalyst, and the copper catalyst is a long-chain alkylsulfonic acid copper salt. By incorporating the long-chain alkylsulfonic acid copper salt in the cationic electrodeposition coating composition, it becomes possible to provide the cationic electrodeposition coating composition with excellent curability and storage stability which have never been obtained with such common copper compounds as copper acetate, copper chloride and copper bromide.

The long-chain alkylsulfonic acid copper salt is the copper salt compound of a long-chain alkylsulfonic acid and is represented by the formula (R—SO₃)₂Cu. The group R is preferably a long-chain alkyl group containing 6 to 24 carbon atoms. When the number of carbon atoms is less than 6, poor storage stability may result and, when it exceeds 24, poor curability may result. More preferably, the above group R is a long-chain alkyl group containing 10 to 16 carbon atoms. The long-chain alkyl group may be a straight aliphatic hydrocarbon group, a branched aliphatic hydrocarbon group, or an aromatic moiety-containing hydrocarbon group. As specific examples of R, there may be mentioned, among others, dodecyl, tetradecyl, hexadecyl and like alkyl groups, octylphenyl, nonylphenyl, dodecylphenyl and like alkylphenyl groups. The group R may contain a polyoxyalkylene unit. In this case, the carbon atoms contained in the polyoxyalkylene unit are not counted as included in the number of carbon atoms of R. As specific examples of R containing a polyoxyalkylene unit, there may be mentioned polyoxyethylenehexadecyl, polyoxyethylenedodecyl and like polyoxyalkylenealkyl groups, polyoxyethylenenonylphenyl, polyoxyethyleneoctylphenyl, polyoxyethylenedodecylphenyl and like polyoxyalkylenealkylphenyl groups, for instance. Here, the polyoxyalkylene unit mentioned above may also be a polyoxypropylene unit. The number of repetitions of the oxyalkylene group in the polyoxyalkylene unit is not particularly restricted but generally is a value well known in the art as leading to surfactant activity when the unit is combined with a long-chain alkyl group. Specifically, a number of 8 to 18 is preferred, and 8 to 12 is more preferred.

The cationic electrodeposition coating composition of the present invention may also contain a long-chain alkylsulfonic acid copper salt in which the number of carbon atoms in R is out of the above range in an amount incapable of affecting the physical properties of that composition.

The long-chain alkylsulfonic acid copper salt can be obtained by reacting a long-chain alkylsulfonic acid salt with a copper compound. The long-chain alkylsulfonic acid salt is not particularly restricted but may be, for example, the sodium salt of the long-chain alkylsulfonic acid. The copper compound is not particularly restricted but includes, among others, copper nitrate, copper chloride, copper bromide, copper perchlorate, copper hydroxide, and copper acetate. Among these, water-soluble ones are preferred.

The content of the long-chain alkylsulfonic acid copper salt is preferably within the range from 0.01 millimole percent (lower limit) to 40 millimole percent (upper limit) on the copper metal basis per 100 g of the resin solids in the cationic electrodeposition coating composition. When it is less than 0.01 millimole percent, any substantial improvement in curability may not be attained. When it exceeds 40 millimole percent, any further effect improvement may not be obtained, hence it is not economical. More preferably, the lower limit is 0.03 millimole percent, and the upper limit is 30 millimole percent.

The cationic electrodeposition coating composition of the present invention comprises a sulfonium group- and propargyl group-containing resin composition. The resin constituting the above resin composition may have both a sulfonium group(s) and a propargyl group(s) within each molecule thereof. This is not always necessary, however. Thus, for example, each molecule may have either a sulfonium group(s) or a propargyl group(s) alone. In the latter case, the resin composition as a whole has both of these two curable functional groups. Thus, the above-mentioned resin composition comprises a sulfonium group- and propargyl group-containing resin, or a sulfonium group-containing resin and a propargyl group-containing resin, or a mixture of all of these. The resin composition contained in the cationic electrodeposition coating composition of the present invention is a sulfonium group- and propargyl group-containing one in the above sense.

The above sulfonium group is a hydratable functional group in the above resin composition. When, in the electrodeposition coating process, a certain level or a higher level of voltage or electric current is applied thereto, the sulfonium group can undergo electrolytic reduction on the electrode and can be irreversibly passivated under ionic group disappearance. Supposedly, this makes it possible for the cationic electrodeposition coating composition of the present invention to show an excellent throwing power.

It is supposed that an electrode reaction is induced in the electrodeposition coating process and the resulting hydroxide ion is retained by the sulfonium group and, as a result, an electrolysis-generated base appears in the electrodeposited coat. This electrolysis-generated base can convert the propargyl group, which occurs in the electrodeposited coat and is low in reactivity upon heating, to the allene bond which is highly reactive upon heating.

The resin to serve as a skeleton of the resin composition contained in the cationic electrodeposition coating composition of the present invention is not particularly restricted but an epoxy resin is judiciously used.

Suited for use as the epoxy resin are those having at least two epoxy groups in each molecule, including epibisepoxy resins, and products derived therefrom by chain extension using a diol, bisphenol, dicarboxylic acid or diamine, for instance; epoxidized polybutadiene; novolak phenol-base polyepoxy resins; novolak cresol-based polyepoxy resins; poly(glycidyl acrylate); aliphatic polyol- or polyether polyol-derived polyglycidyl ethers; polybasic carboxylic acid-derived polyglycidyl esters; and like polyepoxy resins. Among them, novolak phenol-based polyepoxy resins, novolak cresol-based polyepoxy resins, and poly(glycidyl acrylate) are preferred because of the ease of polyfunctionalization for curability enhancement. The epoxy resin may partly comprise a monoepoxy resin.

Preferably, the resin composition contained in the cationic electrodeposition coating composition of the present invention comprises a resin whose skeleton is the above epoxy resin and has a number average molecular weight of 500 (lower limit) to 20000 (upper limit). When this is lower than 500, the cationic electrodeposition coating efficiency will become poor and, when it exceeds 20000, it is no more possible to form good coats on the surface of the articles to be coated. A more preferred number average molecular weight can be selected according to the resin skeleton. In the case of novolak phenol-based epoxy resins and novolak cresol-based epoxy resins, for instance, the lower limit and upper limit are preferably 700 and 5000, respectively.

Preferably, the sulfonium group content in the above resin composition is from 5 millimoles (lower limit) to 400 millimoles (upper limit) per 100 g of the resin solids in the resin composition provided that the total content of the sulfonium and propargyl groups conditions to be mentioned later herein are satisfied. When it is lower than 5 millimoles/100 g, any satisfactory throwing power or good curability cannot be manifested; in addition, the hydratability and bath stability become poor. When it exceeds 400 millimoles/100 g, the coat deposition on the surface of the articles to be coated will worsen. A more preferred sulfonium group content can be selected according to the resin skeleton used. In the case of novolak phenol-based epoxy resins and novolak cresol-based epoxy resins, for instance, the lower limit is preferably 5 millimoles, more preferably 10 millimoles, per 100 g of the solid matter in the resin composition. The upper limit is more preferably 250 millimoles/100 g, still more preferably 150 millimoles/100 g.

The propargyl group possessed by the above resin composition serves as a curing functional group in the cationic electrodeposition coating composition of the present invention. It can still more improve the throwing power of the cationic electrodeposition coating composition in the presence of the sulfonium group, although the reason is unknown.

Preferably, the propargyl group content in the above resin composition is from 10 millimoles (lower limit) to 485 millimoles (upper limit) per 100 g of the resin solids in the resin composition provided that the total content of the sulfonium and propargyl groups conditions to be mentioned later are satisfied. When it is lower than 10 millimoles/100 g, any satisfactory throwing power or good curability cannot be manifested. When it exceeds 485 millimoles/100 g, the hydration stability of the cationic electrodeposition coating composition prepared by using the resin composition may possibly be adversely affected. A more preferred propargyl group content can be selected according to the resin skeleton used. In the case of novolak phenol-based epoxy resins and novolak cresol-based epoxy resins, for instance, the lower limit and upper limit are more preferably 20 millimoles and 375 millimoles, respectively, per 100 g of the solid matter in the resin composition.

The total content of the sulfonium and propargyl groups in the above resin composition is preferably not more than 500 millimoles per 100 g of the solid matter in the resin composition. When it exceeds 500 millimoles/100 g, no corresponding resin can be actually obtained or the desired performance characteristics may not be obtained. A more preferred total content of the sulfonium and propargyl groups in the above resin composition can be selected according to the resin skeleton employed. In the case of novolak phenol-based epoxy resins and novolak cresol-based epoxy resins, for instance, it is more preferably not more than 400 millimoles/100 g.

The propargyl group in the resin composition contained in the cationic electrodeposition coating composition of the present invention may partly be in the form of an acetylide. The acetylide is a salt-like metal-acetylene compound. The content of the acetylide-form propargyl group in the above resin composition is preferably from 0.1 millimole (lower limit) to 40 millimoles (upper limit) per 100 g of the solid matter in the resin composition. When it is lower than 0.1 millimole/100 g, the effect of acetylide formation will not be produced to a satisfactory extent. When it exceeds 40 millimoles/100 g, the acetylide formation becomes difficult. This content can be selected within a more preferred range according to the metal employed.

The metal to be contained in the acetylide-form propargyl group is not particularly restricted but may be any of those metals showing catalytic activity, such as copper, silver, barium and other transition metals. Among these, copper and silver are preferred from the environmental friendliness viewpoint, and copper is more preferred from the availability viewpoint. When copper is used, the acetylide-form propargyl group content in the above resin composition is more preferably 0.1 to 20 millimoles per 100 g of the solid matter in the resin composition.

If desired, the resin composition contained in the cationic electrodeposition coating composition of the present invention may be a carbon-carbon double bond-containing one. The carbon-carbon double bond is highly reactive and therefore can produce a further improvement in curability.

Preferably, the content of the above carbon-carbon double bond is from 10 millimoles (lower limit) to 485 millimoles (upper limit) per 100 g of the resin solids in the resin composition provided that the total content of the propargyl group and carbon-carbon double bond conditions to be mentioned later are satisfied. When it is lower than 10 millimoles/100 g, the addition cannot result in satisfactory curability manifestation. When it exceeds 485 millimoles/100 g, the hydration stability of the cationic electrodeposition coating composition prepared by using the resin composition may possibly be adversely affected. A more preferred carbon-carbon double bond content can be selected according to the resin skeleton used. In the case of novolak phenol-based epoxy resins and novolak cresol-based epoxy resins, for instance, the lower limit and upper limit are more preferably 20 millimoles and 375 millimoles, respectively, per 100 g of the solid matter in the resin composition.

When the above carbon-carbon double bond is contained in the resin composition, the total content of the above propargyl group and carbon-carbon double bond is preferably within the range of from 80 millimoles (lower limit) to 450 millimoles (upper limit) per 100 g of the solid matter in the resin composition. When it is lower than 80 millimoles/100 g, the curability may be insufficient. When it exceeds 450 millimoles/100 g, the sulfonium group content lowers accordingly, hence the throwing power may possibly become insufficient. A more preferred level of the total content of the propargyl group and carbon-carbon double bond can be selected according to the resin skeleton employed. In the case of novolak phenol-based epoxy resins and novolak cresol-based epoxy resins, for instance, the lower limit and upper limit are more preferably 100 millimoles and 395 millimoles, respectively, per 100 g of the solid matter in the resin composition.

When the above carbon-carbon double bond is contained in the resin composition, the total content of the above sulfonium group, propargyl group and carbon-carbon double bond is preferably not more than 500 millimoles per 100 g of the resin solids in the resin composition. When it exceeds 500 millimoles/100 g, no corresponding resin can be actually obtained or the desired performance characteristics may not be obtained. A more preferred level of the total content of the sulfonium group, propargyl group and carbon-carbon double bond can be selected according to the resin skeleton employed. In the case of novolak phenol-based epoxy resins and novolak cresol-based epoxy resins, for instance, it is more preferably not more than 400 millimoles per 100 g of the solid matter in the resin composition.

The resin composition to be contained in the cationic electrodeposition coating composition of the present invention can be advantageously produced, for example, by a step of reacting an epoxy resin having at least two epoxy groups in each molecule with a compound having a functional group capable of reacting with the epoxy group and a propargyl group to give a propargyl group-containing epoxy resin composition (step (i)) and a step of reacting the residual epoxy groups in the propargyl group-containing epoxy resin composition obtained in step (i) with a sulfide/acid mixture for sulfonium group introduction (step (ii)).

The above-mentioned compound having a functional group capable of reacting with the epoxy group and a propargyl group (hereinafter referred to as “compound (A)”) may be a compound containing a functional group capable of reacting with the epoxy group, for example a hydroxyl group or carboxyl group, together with a propargyl group. More specifically, there may be mentioned propargyl alcohol, propargylic acid and so forth. Among these, propargyl alcohol is preferred because of the ready availability and ready reactivity thereof.

When the resin composition to be contained in the cationic electrodeposition coating composition of the present invention is to be provided with a carbon-carbon double bond according to need, a compound having a functional group capable of reacting with the epoxy group as well as a carbon-carbon double bond (hereinafter referred to as “compound (B)”) is used in combination with compound (A) in the above step (i). The above compound (B) may be a compound having a functional group capable of reacting with the epoxy group, for example a hydroxyl group or carboxyl group, together with a carbon-carbon double bond. When the group capable of reacting with the epoxy group is a hydroxyl group, there may more specifically be mentioned 2-hydroxyethyl acrylate, 2-hydroxyethyl methacrylate, hydroxypropyl acrylate, hydroxypropyl methacrylate, hydroxybutyl acrylate, hydroxybutyl methacrylate, allyl alcohol, and methallyl alcohol. When the group capable of reacting with the epoxy group is a carboxyl group, there may be mentioned acrylic acid, methacrylic acid, ethacrylic acid, crotonic acid, maleic acid, phthalic acid, itaconic acid; maleic acid monoethyl ester, fumaric acid monoethyl ester, itaconic acid monoethyl ester, succinic acid mono(meth)acryloyloxyethyl ester, phthalic acid mono(meth)acryloyloxyethyl ester, and like half esters; oleic acid, linolic acid, ricinolic acid, and like synthetic unsaturated fatty acids; linseed oil, soybean oil, and other natural unsaturated fatty acids, etc.

In the above step (i), the above-mentioned epoxy resin having at least two epoxy groups in each molecule is reacted either with the above-mentioned compound (A) to give a propargyl group-containing epoxy resin composition, or with the above compound (A) and, according to need, the above compound (B) to give a propargyl group- and carbon-carbon double bond-containing epoxy resin composition. In the latter case, the above compound (A) and compound (B) may be mixed together in advance and then subjected to reaction in step (i), or may be separately subjected to reaction in step (i). The functional group capable of reacting with the epoxy group in compound (A) and the functional group capable of reacting with the epoxy group in compound (B) may be the same or different.

In the above step (i), the proportions of both the above compound (A) and compound (B) may be selected so that the functional group contents may amount to the respective desired levels, for example the above-mentioned total content of the propargyl group and carbon-carbon double bond may be attained.

As for the reaction conditions in step (i), the reaction is generally carried out at room temperature or 80 to 140° C. for several hours. If necessary, a component(s) required for allowing the reaction to proceed, for example a catalyst and/or a solvent, may be used. The completion of the reaction can be checked by epoxy equivalent measurement, and the functional group introduced can be identified by nonvolatile matter content determination and/or instrumental analysis of the resin composition obtained. The thus-obtained reaction product generally occurs as a mixture of epoxy resins having one or more propargyl groups, or a mixture of epoxy resins having one or more propargyl groups and one or more carbon-carbon double bonds. In this sense, the above step (i) gives a propargyl group-containing, or propargyl group- and carbon-carbon double bond-containing resin composition.

In step (ii), a sulfonium group is introduced into the propargyl group-containing epoxy resin composition obtained in the above step (i) by reacting the residual epoxy group(s) in that epoxy resin composition with a sulfide/acid mixture. The sulfonium group introduction can be realized, for example, by the method comprising reacting the sulfide/acid mixture with the epoxy group(s) for sulfide introduction and sulfonium formation, or by the method comprising first carrying out sulfide introduction and then converting the sulfide introduced to a sulfonium group using an acid or an alkyl halide such as methyl fluoride, methyl chloride or methyl bromide, if necessary followed by anion exchanging. From the ready reactant availability viewpoint, the method using a sulfide/acid mixture is preferred.

The above-mentioned sulfide is not particularly restricted but includes, among others, aliphatic sulfides, aliphatic-aromatic mixed sulfides, aralkyl sulfides, and cyclic sulfides. More specifically, there may be mentioned diethyl sulfide, dipropyl sulfide, dibutyl sulfide, dihexyl sulfide, diphenyl sulfide, ethyl phenyl sulfide, tetramethylene sulfide, pentamethylene sulfide, thiodiethanol, thiodipropanol, thiodibutanol, 1-(2-hydroxyethylthio)-2-propanol, 1-(2-hydroxyethylthio)-2-butanol, 1-(2-hydroxyethylthio)-3-butoxy-1-propanol, and the like.

The above-mentioned acid is not particularly restricted but includes, among others, formic acid, acetic acid, lactic acid, propionic acid, boric acid, butyric acid, dimethylolpropionic acid, hydrochloric acid, sulfuric acid, phosphoric acid, N-acetylglycine, N-acetyl-β-alanine, and the like.

As for the mixing ratio between the above-mentioned sulfide and acid in the above sulfide/acid mixture, a sulfide/acid mole ratio of about 100/40 to 100/120 is generally preferred.

The reaction in the above step (ii) can be carried out, for example, by mixing the propargyl group-containing epoxy resin composition obtained in the above step (i) and such an amount of a mixture of the above-mentioned sulfide and acid that may afford the above-specified sulfonium group content with 5 to 10 moles, relative to the sulfide used, of water and stirring the mixture at 50 to 90° C. for several hours. The end point of the reaction can be known by adopting a residual acid value of 5 or below as a criterion. The sulfonium group introduction in the resin composition obtained can be confirmed by potentiometric titration.

When the sulfonium formation reaction is carried out after sulfide introduction, the reaction can be carried out in the same manner as mentioned above. By carrying out the sulfonium group introduction after propargyl group introduction, as mentioned above, it becomes possible to prevent the sulfonium group from being decomposed upon heating.

When the propargyl group in the resin composition to be contained in the cationic electrodeposition coating composition of the present invention is partly converted to an acetylide form, the acetylide formation can be accomplished by taking a step of reacting the propargyl group-containing epoxy resin composition obtained in the above step (i) with a metal compound to thereby convert a part of the propargyl group in the epoxy resin composition to the corresponding acetylide. The metal compound is preferably a transition metal compound capable of acetylide formation, for example a complex or salt of such a transition metal as copper, silver or barium. More specifically, there may be mentioned, among others, copper acetylacetonate, copper acetate, silver acetylacetonate, silver acetate, silver nitrate, barium acetylacetonate, and barium acetate. Among them, silver and copper compounds are preferred from the environmental friendliness viewpoint, and copper compounds are more preferred from the ready availability viewpoint. Copper acetylacetonate, for instance, is judiciously used in view of the ease of bath control.

As for the reaction conditions for partial conversion of the propargyl group to an acetylide form, the reaction is generally carried out at 40 to 70° C. for several hours. The progress of the reaction can be verified by the coloration of the resulting resin composition or the disappearance of the methine proton in nuclear magnetic resonance spectrometry, for instance. Thus, the time point at which the conversion of the propargyl group in the resin composition to the acetylide form amounts to the desired extent is determined, and the reaction is finished at that time point. The reaction product obtained generally occurs as a mixture of epoxy resins one or more propargyl groups of which have been converted to the acetylide form. The epoxy resin composition obtained in this manner by partially converting the propargyl group to an acetylide form can be subjected to sulfonium group introduction in the step (ii) mentioned above.

The reaction conditions in the step of partially converting the propargyl group of the epoxy resin composition to the acetylide form can be selected so that they may be common with those in the step (ii) mentioned above, hence it is also possible to carry out both steps simultaneously. It is advantageous to carry out both steps simultaneously, since the production process can be simplified.

In this manner, a propargyl group- and sulfonium group-containing resin composition optionally containing a carbon-carbon double bond and optionally having an acetylide moiety resulting from partial conversion of the propargyl group can be produced while inhibiting the decomposition of the sulfonium group. While the acetylide is explosive in a dry condition, the acetylide formation reaction is carried out in an aqueous medium and the desired substance is obtained as an aqueous composition in the practice of the present invention, hence no safety problem arises.

The cationic electrodeposition coating composition of the present invention contains the above-mentioned resin composition, and the resin composition itself has curability. Therefore, it is not always necessary to use a curing agent in the cationic electrodeposition coating composition of the present invention. However, a curing agent may be used for further curability improvement. As such curing agent, there may be mentioned, among others, compounds having propargyl group(s) and/or carbon-carbon double bond(s) in a total amount being two or more, for example compounds obtained by reacting novolak phenol polyepoxide or the like or pentaerythritol tetraglycidyl ether with a propargyl group-containing compound such as propargyl alcohol or a carbon-carbon double bond-containing compound such as acrylic acid in the manner of addition reaction.

In the cationic electrodeposition coating composition of the present invention, there may be further incorporated, where necessary, any of those transition metal compounds or like compounds which are other than the long-chain alkylsulfonic acid copper salt but are in conventional use. Such compounds are not particularly restricted but include, among others, compounds resulting from binding of such a ligand as cyclopentadiene or acetylacetone or such a carboxylic acid as acetic acid to a transition metal such as nickel, cobalt, manganese, palladium, rhodium or cerium. Among them, cerium salt compounds are preferably used from the catalytic activity viewpoint and, among the cerium salt compounds, cerium acetate is preferred. The transition metal compounds are used preferably in an amount of 0.1 millimole (lower limit) to 20 millimoles (upper limit) per 100 g of the solid matter in the cationic electrodeposition coating composition.

An amine may be incorporated in the cationic electrodeposition coating composition of the present invention. The incorporation of the amine results in an increase in the rate of sulfonium-to-sulfide conversion by electrolytic reduction in the process of electrodeposition. The amine is not particularly restricted but includes, among others, such amine compounds as primary to tertiary monofunctional or polyfunctional aliphatic amines, alicylic amines and aromatic amines. Among these, water-soluble or water-dispersible ones are preferred and, as examples, there may be mentioned monomethylamine, dimethylamine, trimethylamine, triethylamine, propylamine, diisopropylamine, tributylamine and like C₂₋₈ alkylamines; monoethanolamine, dimethanolamine, methylethanolamine, dimethylethanolamine, cyclohexylamine, morpholine, N-methylmorpholine, pyridine, pyrazine, piperidine, imidazoline, and imidazole. These may be used singly or two or more of them may be used in combination. Hydroxy amines such as monoethanolamine, diethanolamine and dimethylethanolamine are preferred among others because of their good dispersion stability in water.

The above amine can be directly incorporated in the cationic electrodeposition coating composition of the present invention. In the case of the conventional neutralized type amine-containing cationic electrodeposition coating compositions, the addition of an amine in free form results in deprivation of the neutralizing acid in the resin, with the result that the stability of the electrodeposition bath is markedly deteriorated. In the practice of the present invention, such bath stability inhibition will not occur.

The amount of addition of the amine is preferably 0.3 meq (lower limit) to 25 meq (upper limit) per 100 g of the resin solids in the cationic electrodeposition coating composition. When it is lower than 0.3 meq/100 g, any satisfactory effect on the throwing power cannot be obtained and, when it exceeds 25 meq/100 g, the effect obtainable is no more proportional to the addition level and this is uneconomical. The lower limit is more preferably 1 meq/100 g, and the upper limit is more preferably 15 meq/100 g.

In the cationic electrodeposition coating composition of the present invention, there may also be incorporated an aliphatic hydrocarbon group-containing resin composition. The incorporation of the aliphatic hydrocarbon group-containing resin composition results in an improvement in the shock resistance of the coating films obtained. As the aliphatic hydrocarbon group-containing resin composition, there may be mentioned those containing, per 100 g of the solid matter in the resin composition, 5 to 400 millimoles of a sulfonium group, 80 to 135 millimoles of an aliphatic hydrocarbon group containing 8 to 24 carbon atoms and optionally containing an unsaturated double bond in the chain thereof and 10 to 315 millimoles of at least one of a propargyl group and organic groups containing 3 to 7 carbon atoms and having a terminal unsaturated double bond on condition that the total content of the sulfonium group, the aliphatic hydrocarbon group containing 8 to 24 carbon atoms and optionally containing an unsaturated double bond in the chain thereof and the propargyl group and organic groups containing 3 to 7 carbon atoms and having a terminal unsaturated double bond is not more than 500 millimoles per 100 g of the solid matter in the resin composition.

When such an aliphatic hydrocarbon group-containing resin composition is incorporated in the above cationic electrodeposition coating composition, the resin solid matter in the cationic electrodeposition coating composition preferably contains, per 100 g thereof, 5 to 400 millimoles of sulfonium group, 10 to 300 millimoles of the aliphatic hydrocarbon group containing 8 to 24 carbon atoms and optionally containing an unsaturated double bond in the chain thereof and a total of 10 to 485 millimoles of the propargyl group and organic groups containing 3 to 7 carbon atoms and having a terminal unsaturated double bond, and the total content of the sulfonium group, the aliphatic hydrocarbon group containing 8 to 24 carbon atoms and optionally containing an unsaturated double bond in the chain thereof, the propargyl group and the organic groups containing 3 to 7 carbon atoms and having a terminal unsaturated double bond is not more than 500 millimoles per 100 g of the resin solid matter in the cationic electrodeposition coating composition, and the content of the aliphatic hydrocarbon group containing 8 to 24 carbon atoms and optionally containing an unsaturated double bond in the chain thereof is 3 to 30% by weight relative to the resin solid matter in the cationic electrodeposition coating composition.

When the aliphatic hydrocarbon group-containing resin composition is incorporated in the above cationic electrodeposition coating composition and the sulfonium group content level is lower than 5 millimoles/100 g, any satisfactory throwing power or curability cannot be attained and, further, the hydratability and bath stability will be poor. When it exceeds 400 millimoles/100 g, the deposition of coatings on the surface of the articles to be coated worsens. When the content of the aliphatic hydrocarbon group containing 8 to 24 carbon 6 atoms and optionally containing an unsaturated double bond in the chain thereof is less than 80 millimoles/100 g, the shock resistance will not be improved to a satisfactory extent and, when it exceeds 350 millimoles/100 g, the resin composition becomes difficult to handle. When the total content of the propargyl group and the organic groups containing 3 to 7 carbon atoms and having a terminal unsaturated double bond is less than 10 millimoles/100 g, no satisfactory curability can be manifested on the occasion of combined use of another resin and/or another curing agent and, when it exceeds 315 millimoles/100 g, the shock resistance will not be improved to a satisfactory extent. The total content of the sulfonium group, the aliphatic hydrocarbon group containing 8 to 24 carbon atoms and optionally having an unsaturated double bond in the chain thereof, the propargyl group and the organic groups containing 3 to 7 carbon atoms and having a terminal unsaturated double bond is not more than 500 millimoles per 100 g of the solid matter in the resin composition. When it exceeds 500 millimoles, any corresponding resin cannot be obtained in actuality or the desired performance characteristics cannot be obtained in some instances.

Where necessary, the cationic electrodeposition coating composition of the present invention may further contain one or more of the other components generally used in the conventional cationic electrodeposition coating compositions. The other components are not particularly restricted but include, among others, pigments, rust preventives, pigment dispersing resins, surfactants, antioxidants, ultraviolet absorbers, and other paint additives.

The pigments mentioned above may be added to the above cationic electrodeposition coating composition within the addition amount at which the coating films obtained will not be deteriorated in film appearance or the viscosity of the coating composition will not excessively increase. The pigments are not particularly restricted but include, among others colored pigments such as titanium dioxide, carbon black and red iron oxide; rust preventive pigments such as basic lead silicate and aluminum phosphomolybdate; extender pigments such as kaolin, clay and talc; and other pigments commonly used in cationic electrodeposition coating compositions. As specific examples of the rust preventives, there may be mentioned calcium phosphite, zinc calcium phosphite, calcium-bearing silica, calcium-bearing zeolite and the like. The above pigments and rust preventives are added preferably at a total addition level of 0% by weight (lower limit) to 50% by weight (upper limit) as the solid matter in the cationic electrodeposition coating composition.

The pigment dispersing resins mentioned above are used for stably dispersing the above pigments in the cationic electrodeposition coating composition. The pigment dispersing resins are not particularly restricted but those pigment dispersing resins which are in general use can be used. Sulfonium group- and unsaturated bond-containing pigment dispersing resins may also be used. Such sulfonium group- and unsaturated bond-containing pigment dispersing resins can be obtained, for example, by reacting a hydrophobic epoxy resin, which is obtained by reacting a bisphenol-based epoxy resin with a half blocked isocyanate, with a sulfide compound, or by reacting the above hydrophobic epoxy resin with a sulfide compound in the presence of a monobasic acid and a hydroxyl group-containing dibasic acid. The heavy metal-free rust preventives mentioned above can also be stably dispersed in the cationic electrodeposition coating composition by means of the pigment dispersing resins mentioned above.

The curing temperature for the cationic electrodeposition coating composition of the present invention is preferably selected between 130° C. (lower limit) and 220° C. (upper limit). In cases where coating films consisting of two or more layers are formed, the smoothness of the coating films may possibly decrease when the curing temperature is below 130° C. and, when the curing temperature is above 220° C., the physical properties of the coating films may possibly decrease and, further, the appearance of the coating films obtained by applying a topcoat composition thereto may possibly become deteriorated. The curing temperature can be selected in the manner known in the art, for example by selecting the curable functional group(s), curing agent and catalyst and adjusting the amounts thereof.

The “curing temperature” so referred to herein is the temperature required for obtaining coating films with a gel fraction of 85% by 30 minutes of heating. The gel fraction is measured by the method comprising immersing the test coated plate in acetone, refluxing the acetone for 5 hours, and calculating the difference in weight between the test coated plates before and after testing.

The cationic electrodeposition coating composition of the present invention can be prepared, for example, by adding the long-chain alkylsulfonic acid copper salt mentioned above to the above-mentioned resin composition, adding, according to need, the respective components mentioned above, and dissolving or dispersing the resulting mixture in water. The method of adding the long-chain alkylsulfonic acid copper salt is not particularly restricted but any of the methods known in the art can be used. For example, use can be made of the method comprising adding the copper salt by dispersing the same in the binder to be contained in the cationic electrodeposition coating composition, or the method comprising preparing a paste containing the copper salt using the dispersing resin and then adding the paste obtained in or after the step of producing the coating composition. For use in cationic electrodeposition coating, the cationic electrodeposition coating composition is preferably prepared in the form of a solution with a nonvolatile matter content of 10% by weight (lower limit) to 30% by weight (upper limit). Further, the cationic electrodeposition coating composition is preferably prepared so that the propargyl group, carbon-carbon double bond and sulfonium group contents therein may not deviated from the respective ranges shown referring to the resin composition mentioned above.

The method of stabilizing cationic electrodeposition coating compositions according to the present invention improves the storage stability in a stationary condition, which has been a problem in the art, by causing them to contain a specific copper compound as a copper catalyst. It is known in the art that the use of copper ions can improve the curability of cationic electrodeposition coating compositions. However, when such common copper compounds as copper acetate, copper chloride and copper bromide are used, problems arise, namely oxidative polymerization takes place in the coating compositions, or resin coagulation occurs, rendering the electrodeposition coating compositions unstable. In accordance with the present invention, cationic electrodeposition coating compositions are stabilized by incorporating a long-chain alkylsulfonic acid copper salt or a long-chain alkylsulfuric acid copper salt as the copper catalyst.

As examples of the long-chain alkylsulfonic acid copper salt, there may be mentioned the same compounds as mentioned above, which are to be used in the cationic electrodeposition coating composition of the present invention. Preferred addition amounts thereof in the cationic electrodeposition coating compositions are also the same as mentioned hereinabove.

The long-chain alkylsulfuric acid copper salt is the copper salt compound of a long-chain alkylsulfuric acid and is represented by the formula Cu(ROSO₃)₂. The group R is preferably a long-chain alkyl group containing 6 to 24 carbon atoms. When the number of carbon atoms is less than 6, the storage stability will be poor and, when it exceeds 24, the storage stability may possibly become unsatisfactory. The above group R is more preferably a long-chain alkyl group containing 10 to 16 carbon atoms. The long-chain alkyl group may be a straight aliphatic hydrocarbon group, a branched aliphatic hydrocarbon group, or an aromatic moiety-containing hydrocarbon group. Specific examples of R are such alkyl groups as dodecyl and hexadecyl, and such alkylphenyl groups as octylphenyl, nonylphenyl and dodecylphenyl. The group R may further contain a polyoxyalkylene unit. In this case, the carbon atoms contained in the polyoxyalkylene unit are not counted as included in the number of carbon atoms of R. As specific examples of R containing a polyoxyalkylene unit, there may be mentioned polyoxyethylenehexadecyl, polyoxyethylenedodecyl and like polyoxyalkylenealkyl groups, polyoxyethylenenonylphenyl, polyoxyethyleneoctylphenyl, polyoxyethylenedodecylphenyl and like polyoxyalkylenealkylphenyl groups, among others. Here, the polyoxyalkylene unit mentioned above may also be a polyoxypropylene unit. The number of repetitions of the oxyalkylene group in the polyoxyalkylene unit is not particularly restricted but generally is a value well known in the art as leading to surfactant activity when the unit is combined with a long-chain alkyl group. Specifically, a number of 8 to 18 is preferred, and 8 to 12 is more preferred.

The cationic electrodeposition coating composition may also contain a long-chain alkylsulfuric acid copper salt in which the number of carbon atoms in R is out of the above range in an amount incapable of affecting the physical properties of that composition.

The above long-chain alkylsulfuric acid copper salt can be obtained by reacting a long-chain alkyl sulfuric acid ester salt with a copper compound. The long-chain alkyl sulfuric acid ester salt is not particularly restricted but may be the sodium salt of such a long-chain alkylsulfuric acid as mentioned above. The copper compound is not particularly restricted but includes, among others, copper nitrate, copper chloride, copper bromide, copper perchlorate, copper hydroxide, and copper acetate. Among these, water-soluble ones are preferred.

When dodecyl sulfuric acid ester sodium salt is used as the long-chain alkyl sulfuric acid ester salt and copper nitrate as the copper compound, salt exchange takes place and dodecyl sulfuric acid ester copper salt is formed and precipitated, and the subsequent filtration gives the desired product. That this reaction gives Cu(C₁₂H₂₅OSO₃)₂.4H₂O is described by C. S. Bruschini et al. in Polyhedron, 14, 3099-106 (1995).

The content of the long-chain alkylsulfuric acid copper salt is preferably within the range of from 0.01 millimole percent (lower limit) to 40 millimole percent (upper limit) on the copper metal basis per 100 g of the resin solids in the cationic electrodeposition coating composition. When it is less than 0.01 millimole percent, the stabilizing effect may possibly be unsatisfactory. When it exceeds 40 millimole percent, any additional improvement in stabilizing effect may not be obtained, hence it is uneconomical. More preferably, the lower limit is 0.03 millimole percent, and the upper limit is 30 millimole percent.

In practicing the method of stabilizing cationic electrodeposition coating compositions according to the present invention, the long-chain alkylsulfonic acid copper salts and long-chain alkylsulfuric acid copper salts mentioned above may be used singly or in combination.

The cationic electrodeposition coating composition to be used in the practice of the present invention contains a sulfonium group- and propargyl group-containing resin composition. The above cationic electrodeposition coating composition is the same as described hereinabove.

The cationic electrodeposition coating composition of the present invention comprises a sulfonium group- and propargyl group-containing resin composition and a copper catalyst. As a result of its containing a long-chain alkylsulfonic acid copper salt as the copper catalyst, the curability can be enhanced without using any heavy metal-containing metal catalyst and, further, a method of improving the storage stability of cationic electrodeposition coating compositions in a stationary state can be provided as a result of causing the compositions to contain a long-chain alkylsulfonic acid copper salt or a long-chain alkylsulfuric acid copper salt.

### EXAMPLES

The following examples illustrate the present invention more specifically. These examples are, however, by no means limitative of the scope of the present invention. In the examples, “part(s)” means “part(s) by weight” unless otherwise specified.

### Production Example 1

### Production of a Sulfonium Group- and Propargyl Group-Containing Epoxy Resin Composition

A separable flask equipped with a stirrer, thermometer, nitrogen inlet tube and reflux condenser was charged with 100.0 parts of Epo Tohto YDCN 701 (cresol novolak-based epoxy resin, product of Tohto Kasei) with an epoxy equivalent of 200.4, 23.6 parts of propargyl alcohol and 0.3 part of dimethylbenzylamine, the temperature was raised to 105° C., and the reaction was allowed to proceed for 3 hours to give a propargyl group-containing resin composition with an epoxy equivalent of 1580. To this composition was added 2.5 parts of copper acetylacetonate, and the reaction was allowed to proceed at 50° C. for 1.5 hours. Partial disappearance of the terminal hydrogen of the propargyl group added was confirmed by proton (1H) NMR (the content of the acetylide-form propargyl group being 14 millimoles/100 g of the resin solids). Thereto were added 10.6 parts of 1-(2-hydroxyethylthio)-2,3-propanediol, 4.7 parts of glacial acetic acid and 7.0 parts of deionized water, and the reaction was allowed to proceed for 6 hours while maintaining the temperature at 75° C. After confirmation of the residual acid value being not more than 5, 43.8 parts of deionized water was added to give the desired resin composition solution. This had a solid matter concentration of 70.0% by weight and a sulfonium value of 28.0 millimoles/100 g varnish. The number average molecular weight was 2443 (polystyrene equivalent determined by GPC).

### Production Example 2

### Production of a Pigment Dispersing Resin Composition

A separable flask equipped with a stirrer, thermometer, nitrogen inlet tube and reflux condenser was charged with 100.0 parts of a cresol novolak-based epoxy resin (Epo Tohto YDCN 701, trademark, product of Tohto Kasei) with an epoxy equivalent of 200.4, 13.5 parts of propargyl alcohol and 0.2 part of dimethylbenzylamine, the temperature was raised to 105° C., and the reaction was allowed to proceed for 1 hour to give a propargyl group-containing resin composition with an epoxy equivalent of 445. Thereto were added 50.6 parts of linolic acid and an additional 0.1-part portion of dimethylbenzylamine, and the reaction was continued at the same temperature for 3 hours to give a propargyl group- and long-chain unsaturated fatty acid residue-containing resin composition with an epoxy equivalent of 2100. Thereto were added 10.6 parts of 1-(2-hydroxyethylthio)-2,3-propanediol, 4.7 parts of glacial acetic acid and 7.0 parts of deionized water, and the reaction was allowed to proceed for 6 hours while maintaining the temperature at 75° C. After confirmation of the residual acid value being not more than 5, 62.9 parts of deionized water was added to give a pigment dispersing resin composition solution. This had a solid matter concentration of 69.3% by weight and a sulfonium value of 23.5 millimoles/100 g varnish. The number average molecular weight was 3106 (polystyrene equivalent determined by GPC).

### Example 1

### Preparation of a Cationic Electrodeposition Coating Composition

An aqueous solution with a solid matter concentration of 23.5% by weight was prepared by mixing up 810 parts of the epoxy resin composition obtained in Production Example 1, 3.24 parts of a long-chain alkylsulfuric acid copper salt (copper dodecylsulfate: 75% by weight) and 1174 parts of deionized water by stirring with a high-speed rotary mixer for 1 hour, followed by further addition of 2030 parts of deionized water. Further, a solution of 1.7 parts of cerium acetate in deionized water was added thereto, 12 parts of N-methylethanolamine was then added, and the resulting aqueous solution was adjusted to a solid matter concentration of 20.0% to give a cationic electrodeposition coating composition.

[Coating Film Formation]

The cationic electrodeposition coating composition obtained in Example 1 was transferred to a stainless steel vessel and used as an electrodeposition bath. Therein, electrodeposition coating was carried out using a zinc phosphate-treated cold-rolled steel plate (JIS G 3141 SPCC-SD, treated with Nippon Paint's zinc phosphate treating agent Surfdyne SD-5000) as the cathode. After electrodeposition coating, the coated article was taken out of the electrodeposition bath in the stainless steel vessel, washed with water, and the thus-formed uncured cationic electrodeposited coat was baked at 180° C. for 20 minutes. A coated article with an electrodeposited coating film formed thereon was thus obtained.

Separately, the cationic electrodeposition coating composition obtained in Example 1 was allowed to stand at 40° C. for 1 month without stirring and then cationic electrodeposition coating was carried out using the same in the same manner as mentioned above to give an electrodeposited coating film.

### Example 2

A cationic electrodeposition coating composition was prepared and electrodeposited coating films were produced in the same manner as in Example 1 except that the long-chain alkylsulfuric acid copper salt used had a composition of 59% by weight of copper tetradecylsulfate (of which 22% by weight was copper isotetradecylsulfate).

Further, like in Example 1, the cationic electrodeposition coating composition obtained was allowed to stand at 40° C. for 1 month without stirring and, then, cationic electrodeposition coating was carried out using the same to give an electrodeposited coating film.

### Example 3

A cationic electrodeposition coating composition was prepared and electrodeposited coating films were produced in the same manner as in Example 1 except that the long-chain alkylsulfuric acid copper salt used had a composition of 69% by weight of copper tetradecylsulfate (of which 50% by weight was copper isotetradecylsulfate).

Further, like in Example 1, the cationic electrodeposition coating composition obtained was allowed to stand at 40° C. for 1 month without stirring and, then, cationic electrodeposition coating was carried out using the same to give an electrodeposited coating film.

### Example 4

A cationic electrodeposition coating composition was prepared by adding a paste obtained by mixing/dispersing, with/in 43.2 parts of the pigment dispersing resin composition obtained in Production Example 2, such an amount of copper dodecylsulfate as corresponding to 1.8% by weight relative to the weight of the solid matter in the desired cationic electrodeposition coating composition, to a mixture of 101.0 parts of the resin composition obtained in Production Example 1 and 155.8 parts of deionized water, stirring the mixture with a high-speed rotary mixer for 1 hour, and further adding 373.3 parts of deionized water to adjust the aqueous solution to a solid matter concentration of 15% by weight. Further, an electrodeposited coating film was formed in the same manner as in Example 1.

Further, like in Example 1, the cationic electrodeposition coating composition obtained was allowed to stand at 40° C. for 1 month without stirring and, then, cationic electrodeposition coating was carried out using the same to give an electrodeposited coating film.

### Example 5

A cationic electrodeposition coating composition was prepared and electrodeposited coating films were produced in the same manner as in Example 1 except that copper dodecylsulfonate (product of TAYCA Corp.) was used in lieu of the long-chain alkylsulfuric acid copper salt.

Further, like in Example 1, the cationic electrodeposition coating composition obtained was allowed to stand at 40° C. for 1 month without stirring and, then, cationic electrodeposition coating was carried out using the same to give an electrodeposited coating film.

### Comparative Example 1

A cationic electrodeposition coating composition was prepared and electrodeposited coating films were produced in the same manner as in Example 1 except that, on the occasion of adding cerium acetate, 0.8 part of copper acetate was added in lieu of the long-chain alkylsulfuric acid copper salt.

Further, like in Example 1, the cationic electrodeposition coating composition obtained was allowed to stand at 40° C. for 1 month without stirring and, then, cationic electrodeposition coating was carried out using the same to give an electrodeposited coating film.

The coated articles obtained in Examples 1, 2, 3, 4 and 5 and Comparative Example 1 were measured for dry film thickness and evaluated with respect to the following item. The results obtained are shown in Table 1.

(Evaluation Method)

<Surface Roughness (Ra)value)>

The surface roughness (Ra value) of the surface of each coated article was measured using a surface roughness meter (“SJ-201”, product of Mitutoyo Corp.). As for the measurement conditions, the cut-off was 0.8 mm or 2.5 mm. A greater value indicates a rougher surface condition. The results are shown in Table 1. The number in the bracket represents the cut-off value.

TABLE 1

| | | Example | | | | | Compar. |
|---|---|---|---|---|---|---|---|
| | | 1 | 2 | 3 | 4 | 5 | Ex. 1 |
| Initial | Dry film | 15.0 | 15.0 | 15.0 | 15.0 | 15.0 | 15.0 |
| | thickness | | | | | | |
| | (μm) | | | | | | |
| | Ra (0.8) | 0.23 | 0.24 | 0.25 | 0.26 | 0.25 | 0.28 |
| | Ra (2.5) | 0.33 | 0.30 | 0.38 | 0.40 | 0.39 | 0.35 |
| After 1 | Dry film | 16.0 | 16.5 | 15.8 | 16.4 | 16.0 | 14.0 |
| month of | thickness | | | | | | |
| standing | (μm) | | | | | | |
| | Ra (0.8) | 0.25 | 0.25 | 0.27 | 0.29 | 0.28 | 0.47 |
| | Ra (2.5) | 0.36 | 0.32 | 0.40 | 0.44 | 0.47 | 0.68 |

The Ra values of the coated articles obtained in Examples 1, 2, 3, 4 and 5 with the respective coating compositions after 1 month of storage did not show any significant differences from the initial values. On the contrary, in Comparative Example 1 in which either the long-chain alkylsulfuric acid copper salt or the long-chain alkylsulfonic acid copper salt was not used but copper acetate was used, the Ra value after 1 month of storage of the coating composition clearly showed an increase.

These results demonstrated that the present invention is effective in improving the storage stability in a stationary condition through incorporation of a long-chain alkylsulfonic acid copper salt or a long-chain alkylsulfuric acid copper salt. It was also established that the number of carbon atoms in the long-chain alkylsulfuric acid copper salt to be used in the practice of the present invention is preferably not smaller than 6 but not greater than 24. Furthermore, since there was no significant difference in stationary condition storage stability-improving effect between Examples 2 and 3, it was shown that the effect of the present invention is not much influenced by whether the long-chain alkyl group is straight or branched.

### Comparative Example 2

A cationic electrodeposition coating composition was prepared and electrodeposited coating films were produced in the same manner as in Example 1 except that nickel acetylacetonate was used in lieu of the long-chain alkylsulfuric acid copper salt and 0.8 part of copper acetate was added on the occasion of adding cerium acetate.

Further, like in Example 1, the cationic electrodeposition coating composition obtained was allowed to stand at 40° C. for 1 month without stirring and, then, cationic electrodeposition coating was carried out using the same to give an electrodeposited coating film.

The coated articles obtained in Example 5 and Comparative Examples 1 and 2 were evaluated with respect to the following item.

(Evaluation Test)

<Curability Evaluation>

Each electrodeposited coating film obtained was placed in a Soxhlet extractor and extracted under acetone refluxing conditions for 6 hours, and the gel fraction of the coating film was calculated as follows. The results are shown in Table 2.
Gel fraction (%)=[weight after extraction (g)/weight before extraction (g)]×100

TABLE 2

| | | EX. 5 | Compar. Ex. 1 | Compar. Ex. 2 |
|---|---|---|---|---|
| Gel | 160° C. × 20 min | 90% | 80% | 90% |
| fraction | 160° C. × 25 min | 93% | 85% | 92% |
| | 170° C. × 25 min | 96% | 92% | 96% |

| | | | |
|---|---|---|---|
| Heavy metal component | Not | Not | Containing |
| | containing | containing | |

It was confirmed that the coated article obtained in Example 5 in which copper dodecylsulfonate was incorporated was satisfactory in curability. On the contrary, the heavy metal-free one failed to show satisfactory curability. These facts indicated that the incorporation of copper dodecylsulfonate in a cationic electrodeposition coating composition can afford a level of curability which is at least comparable to that attainable when the composition contains a heavy metal.

### INDUSTRIAL APPLICABILITY

The cationic electrodeposition coating composition of the present invention, which contains a long-chain alkylsulfonic acid copper salt, shows good curability without containing any heavy metal. This is presumably due to the fact that the long-chain alkylsulfonic acid copper salt acts as a curing catalyst against the base resin, namely the propargyl group- and sulfonium group-containing epoxy resin.

The method of stabilizing cationic electrodeposition coating compositions according to the present invention, according to which a long-chain alkylsulfonic acid copper salt or a long-chain alkylsulfuric acid copper salt is incorporated in the cationic electrodeposition coating compositions, can prevent the coating films obtained by coating film formation using the cationic electrodeposition coating compositions after storage in a stationary condition from becoming deteriorated in smoothness.

1. A cationic electrodeposition coating composition comprising a sulfonium group- and propargyl group-containing resin composition and a copper catalyst,
said copper catalyst being a long-chain alkylsulfonic acid copper salt.

2. The cationic electrodeposition coating composition according to claim 1,
wherein the long-chain alkyl group in the long-chain alkylsulfonic acid copper salt contains 6 to 24 carbon atoms.

3. A method of stabilizing cationic electrodeposition coating compositions comprising a sulfonium group- and propargyl group-containing resin composition and a copper catalyst,
said method comprising using a long-chain alkylsulfonic acid copper salt or a long-chain alkylsulfuric acid copper salt as the copper catalyst.

4. The method of stabilizing cationic electrodeposition coating compositions according to claim 3,
wherein the long-chain alkyl group in the long-chain alkylsulfonic acid copper salt or long-chain alkylsulfuric acid copper salt contains 6 to 24 carbon atoms.
